(19) United States
(12) Patent Application Publication
(10) Pub. No.: US 2006/0075011 A1
(43) Pub. Date: Apr. 6, 2006

(54) System and method for optimizing polynomial expressions in a processing environment

(75) Inventor: Farzan Fallah, San Jose, CA (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 11/084,358

(22) Filed: Mar. 17, 2005

Related U.S. Application Data
(60) Provisional application No. 60/612,387, filed on Sep. 23, 2004.

(51) Int. Cl. G06F 7/38

(52) U.S. Cl. 708/490

(57) ABSTRACT

A method for optimizing polynomial expressions is provided that includes generating kernels in order to form a kernel and co-kernel matrix and generating a cube literal matrix, which includes a plurality of cubes. Rectangles are identified on the kernel and co-kernel matrix and the rectangles are used to find common factors between the kernels. The rectangles on the cube literal matrix are identified and the rectangles are used to find common factors between the cubes.

### RELATED APPLICATIONS

This application claims the priority under 35 U.S.C. §119 of provisional application Ser. No. 60/612,387 filed Sep. 23, 2004.

### TECHNICAL FIELD OF THE INVENTION

The present invention relates generally to digital signal processor (DSP) design and, more particularly, to a system and a method for optimizing polynomial expressions in a processing environment.

### BACKGROUND OF THE INVENTION

The proliferation of integrated circuits has placed increasing demands on the design of digital systems included in many devices, components, and architectures. The number of digital systems that include integrated circuits continues to steadily increase and is driven by a wide array of products and systems. Added functionalities may be implemented in integrated circuits in order to execute additional tasks or to effectuate more sophisticated operations in their respective applications or environments.

In the context of processing, present generation embedded systems have stringent requirements on performance and power consumption. Many embedded systems employ digital signal processing (DSP) algorithms for communications, image processing, video processing etc, which can be computationally intensive. The growing consumer demands have fuelled the development of sophisticated applications like 3-D video graphics to be implemented in embedded systems. These algorithms each include and implicate any number of processing operations. The required processing operations (e.g. multiplications, additions, subtractions, etc.) are paramount in any proposed processing optimization. Moreover, it is the operations themselves that dictate the demands, capacity, and capabilities of any given system architecture or configuration. Accordingly, the ability to reduce these operations to achieve optimal processing provides a significant challenge to system designers and component manufacturers alike.

### SUMMARY OF THE INVENTION

From the foregoing, it may be appreciated by those skilled in the art that a need has arisen for an improved processing approach for minimizing the number of operations. In accordance with the present invention, techniques for reducing operations in polynomial expressions are provided. According to specific embodiments, these techniques can optimize a given set of equations by eliminating any number of common subexpressions involving any number of variables and integer exponents of the variables.

According to a particular embodiment, a method for optimizing polynomial expressions is provided that includes generating kernels in order to form a kernel and co-kernel matrix and generating a cube literal matrix, which includes a plurality of cubes. Rectangles are identified on the kernel and co-kernel matrix and the rectangles are used to find common factors between the kernels. The rectangles on the cube literal matrix are identified and the rectangles are used to find common factors between the cubes.

Embodiments of the invention may provide various technical advantages. Certain embodiments provide for a significant reduction in operations for an associated processing architecture. One key element of the present invention relates to the development of a methodology that can factor and eliminate common subexpressions in a set of polynomial expressions, which are of any order and which contain any number of variables. These techniques have been adapted from the algebraic techniques that have been established for multi-level logic synthesis. These algorithms give significant opportunities for optimizing performance and power consumption in embedded applications. These techniques yield a minimal number of multiplies and additions/subtractions in contrast to other techniques. Synthesis results, on a subset of these examples, reflect an implementation with less area and faster throughput in comparison to conventional techniques. Hence, the present invention can achieve a saving in operations, which provides for less power consumption and smaller area configurations. Such an approach may be ideal for the design of digital signal processing hardware.

Other technical advantages of the present invention may be readily apparent to one skilled in the art. Moreover, while specific advantages have been enumerated above, various embodiments of the invention may have none, some, or all of these advantages.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates a digital signal processor (DSP) system for eliminating common subexpressions according to various embodiments of the present invention;

FIG. 2 is a more detailed diagram of polynomial expressions;

FIG. 3 is a simplified diagram illustrating the differences in the properties on which Boolean and arithmetic expressions are based on;

FIG. 4 is a simplified diagram illustrating a kernel generation for the polynomial expressions;

FIG. 5 is a simplified diagram showing the result of the kernel and co-kernel generation for the example.

FIG. 6 is a simplified kernel-cube matrix associated with the system;

FIG. 7 is a simplified diagram illustrating optimization of the polynomial expressions;

FIG. 8 is a simplified example diagram of a cube-literal matrix for the polynomial expressions;

FIG. 9 is a simplified diagram illustrating optimization of the polynomial expressions; and

FIG. 10 is a simplified diagram illustrating an example computation.

### DETAILED DESCRIPTION OF THE DRAWINGS

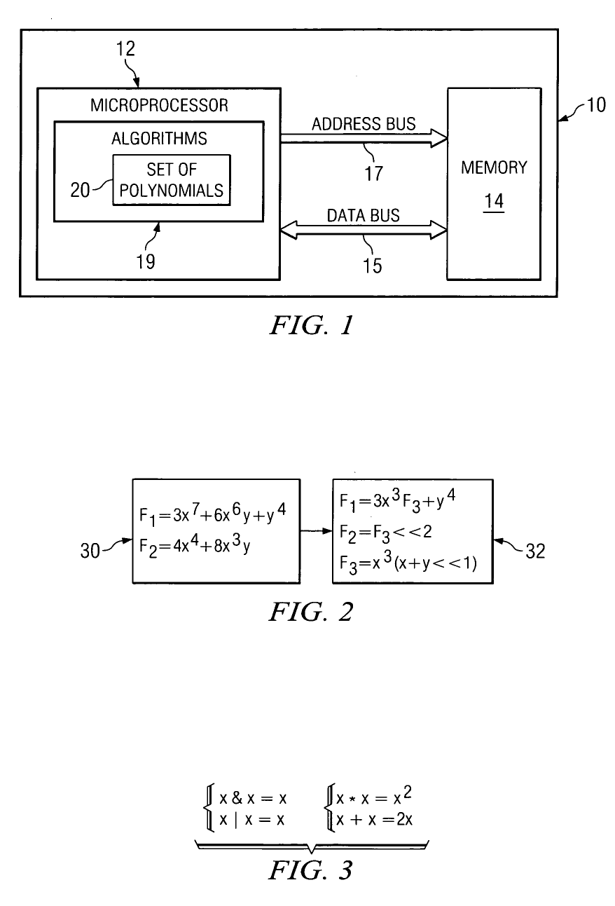

FIG. 1 is a simplified diagram illustrating a portion of a system 10, which operates in a digital signal processor (DSP) environment. System 10 includes a microprocessor 12 and a memory 14 coupled to each other using an address bus 17 and a data bus 15. Microprocessor 12 includes one or more algorithms 19, which include a set of polynomial expressions 20 to be evaluated.

In accordance with the teachings of the present invention, system 10 operates to optimize polynomial expressions 20, which may be used in signal processing operations. The present invention addresses polynomials, which can involve powers of variables. In general polynomial expressions are used to evaluate a number of functions in Digital Signal Processing, where they are used to approximate certain transcendental functions. Furthermore, they are also used to model non-linearities in high speed communication channels. Another important application of polynomials is in the modeling of surfaces, curves, shapes and textures in computer graphics.

Common subexpression elimination (CSE) is a compiler technique commonly employed to reduce the redundant operations in a program. The conventional CSE algorithm is not suited for optimizing polynomials because it cannot do factorization and find complex subexpressions involving many operations. System 10 transforms these computations such that all possible algebraic common subexpressions and factors involving any order and any number of variables can be detected. Heuristic algorithms can then be presented in order to select the best set of common subexpressions.

Therefore it can be seen that polynomial expressions are widely used to compute a wide variety of mathematical functions commonly found in signal processing and graphics applications, which provide good opportunities for optimization. Unfortunately the existing techniques such as common subexpression elimination and value numbering are either targeted towards general-purpose applications and are unable to fully optimize these expressions or popular methods like Homer transform, are restricted in utility to only single variable polynomial expressions. The present invention aims at overcoming these drawbacks in present methods and offers algorithms to reduce the number of operations to compute a set of polynomial expression by factoring and eliminating common subexpressions. These algorithms are based on the algebraic techniques for multi-level logic synthesis.

System 10 offers a new transformation of polynomial expressions that helps to perform these optimizations. Heuristic algorithms are then used to extract common computations from this transformation. Synthesis results for system 10 measured over a set of benchmark polynomial functions yield an implementation with less area and higher throughput and lower energy consumption, as compared to conventional common subexpression elimination techniques.

Referring back to FIG. 1, microprocessor 12 may be included in any appropriate arrangement and, further, include algorithms 19 (e.g. ping pong algorithms, rectangle covering algorithms, extraction algorithms, etc.) embodied in any suitable form (e.g. software, hardware, etc.). For example, microprocessor 12 may be part of a simple integrated chip, an application specific integrated circuit (ASIC), a field programmable gate array (FPGA), or any other suitable processing object, device, or component. Address bus 17 and data bus 15 are wires capable of carrying data (e.g. binary data). Alternatively, such wires may be replaced with any other suitable technology (e.g. optical radiation, laser technology, etc.) operable to facilitate the propagation of data.

Memory 14 is a storage element operable to maintain information that may be accessed by microprocessor 12. Memory 14 may be a random access memory (RAM), a read only memory (ROM), an erasable programmable ROM (EPROM), an electrically erasable programmable ROM (EEPROM), a fast cycle RAM (FCRAM), a static RAM (SRAM), or any other suitable object that is operable to facilitate such storage operations. In other embodiments, memory 14 may be replaced by another processor that is operable to interface with microprocessor 12.

For purposes of teaching and discussion, it is useful to provide some overview as to the way in which the following invention operates. The following foundational information may be viewed as a basis from which the present invention may be properly explained. Such information is offered earnestly for purposes of explanation only and, accordingly, should not be construed in any way to limit the broad scope of the present invention and its potential applications.

The rapid advancement and specialization of embedded systems has pushed the compiler designers to develop application specific techniques to get the maximum benefit at the earliest stages of the design process. There are a number of embedded system applications that have to frequently compute polynomial expressions. Polynomial expressions are present in a wide variety of applications domains since any continuous function can be approximated by a polynomial to the desired degree of accuracy. There are a number of scientific applications that use polynomial interpolation on data of physical phenomenon. These polynomials need to be computed frequently during simulation. Real time computer graphics applications often use polynomial interpolations for surface and curve generation, texture mapping etc. Most DSP algorithms often use trigonometric functions like Sine and Cosine, which can be approximated by their Taylor series as long as the resulting inaccuracy can be tolerated.

There are a number of compiler optimizations for reducing code complexity such as value numbering, common subexpression elimination, constant propagation, strength reduction etc. These optimizations are performed both locally in a basic block and globally across the whole procedure, and are typically applied at a low-level intermediate representation of the program. However, these optimizations have been developed for general-purpose applications and are unable to fully optimize polynomial expressions. Most importantly, they are unable to perform factorization, which is a very effective technique in reducing the number of multiplications in a polynomial expression.

For example, consider the evaluation of the trigonometric identity sin(x), which can be approximated using Taylor series. The subscript under each term denotes the term number in the expression.

A rudimentary implementation of this expression will result in fifteen multiplications and three additions/subtractions. Consider:
sin(x)=x₍₁₎−S₃x³₍₂₎+S₅x⁵₍₃₎−S₇x⁷₍₄₎; and
S₃=⅓!, S₅=⅕!, S₇= 1/7!.

Common subexpression elimination (or CSE) is typically applied on a low-level intermediate program representation, and it iteratively detects and eliminates two operand common subexpressions. When CSE is applied to the expression, the subexpression d₁=x*x is detected in the first iteration. In the second iteration, the subexpression d₂=d₁*d₁ is detected, and the algorithm stops. The optimized expression is now written as:
d₁=x*x;
d₂=d₁*d₁; and
sin(x)=x−(S₃*x)*d₁+(S₅*x)*d₂−(S₇*x)*(d₂*d₁).

These expressions consist of a total of nine multiplications and three additions/subtractions: yielding a saving of six multiplications over the previous evaluation. Using algebraic techniques of the present invention, the following set of expressions can be generated:
d₄=x*x;
d₂=S₅−S₇*d₄;
d₁=d₂*d₄−S₃;
d₃=d₁*d₄+1; and
sin(x)=x*d₃.

These expressions now consist of a total of five multiplications and three additions/subtractions. Therefore, there is a saving of four multiplications compared to the previous technique and a saving of ten multiplications compared to the original representation.

It should be noted that this representation is similar to the hand optimized form of the Horner transform used to evaluate trigonometric functions. This can be done by manually finding common subexpressions after using the Horner to optimize the polynomial. It is impossible to perform such optimizations using the conventional compiler techniques. Using the present invention, such optimizations can be done automatically for any set of arithmetic expressions using algebraic techniques.

Decomposition and factoring are the major techniques in multi-level logic synthesis, and are used to reduce the number of literals in a set of Boolean expressions. The same concepts can be used to reduce the number of operations in a set of arithmetic expressions. In particular, the present invention provides: 1) transformation of the set of arithmetic expressions that allow for detection of all possible common subexpressions and factors; 2) algorithms to find the best set of factors and common subexpressions to reduce number of operations; and 3) a demonstrable superiority of the proposed technique over CSE and Horner transform operations.

Before explaining the techniques and the figures in this document, some of the terminology used in our technique is explained here. Each polynomial expression is represented by an integer matrix where there is one row for each product term (cube), and one column for each variable/constant in the matrix. Each element (i,j) in the matrix is a non-negative integer that represents the exponent of the variable j in the product term i. There is an additional field in each row of the matrix for the sign (±) of the corresponding product term. A literal is a variable or a constant (e.g. a, b, 2, 3.14 . . . ). A cube is a product of the variables each raised to a non-negative integer power. In addition, each cube has a positive or a negative sign associated with it. Examples of cubes are +3a²b, −2a³b²c. An SOP (Sum of Products) representation of a polynomial is the sum of the cubes (+3a²b +(−2a³b²c)+. . . ). An SOP expression is said to be cube-free if there is no cube that divides all the cubes of the SOP expression. For a polynomial P and a cube c, the expression P/c is a kernel if it is cube-free and has at least two terms (cubes). For example in the expression P=3a²b−2a³b²c, the expression P/(a²b)=(3−2abc) is a kernel. The cube that is used to obtain a kernel is called a co-kernel. In the above example, the cube a²b is a co-kernel. The literals, cubes, kernels, and co-kernels are represented in matrix form in our technique.

Arithmetic expressions (functions or polynomials) are extensively used in many processing applications (some of which were highlighted above) and exist in Bayesian networks, scientific computing, and are generally applicable to a wide array of DSP environments. These expressions require many additions/subtractions and multiplications, which can be expensive. While there has been extensive work in logic synthesis (i.e. Boolean functions), little attention has been paid to optimizing arithmetic expressions (e.g. elimination of common subexpressions). Note that polynomial expressions 20 are provided in terms of integer variables.

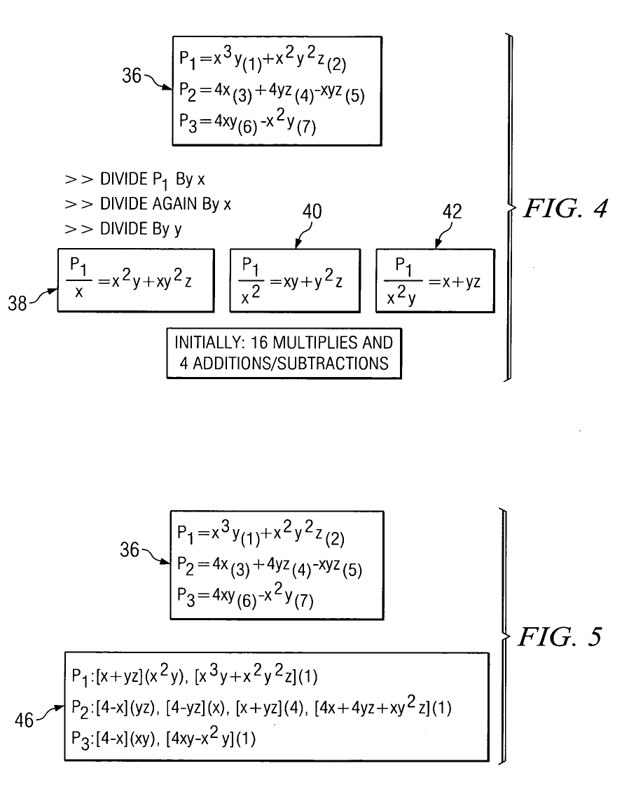

FIG. 2 is a set of polynomials showing an example of the proposed optimizations. A set of equations 32 has been provided to illustrate optimization of multi-output arithmetic functions. This is analogous to the multi-output logic synthesis. FIG. 3 is a simplified diagram illustrating the principles of Boolean expressions (on the left) and arithmetic expressions (on the right). The operation of the present invention is based on rectangle covering algorithm, which is used in logic synthesis. This algorithm has been modified such that it can handle arithmetic expressions. The modification are due to the differences in properties of the Boolean operations (AND and OR operations) over arithmetic operators (multiplication and addition operations), which is illustrated in FIG. 4.

FIG. 4 is a simplified diagram illustrating a kernel generation for the polynomial expressions. A set of equations 36 are provided and a series of operations 38, 40, and 42 are then performed in this example. Operation 38 involves dividing P₁ by X; operation 40 involves dividing again by X; and operation 42 involves dividing by Y. This yields the kernel expression (x+yz) and the corresponding co-kernel (x²y).

The importance of kernels is illustrated by the following theorem:

Theorem: There is a multiple term (algebraic) common subexpression in the set of polynomial expressions if and only if there is a multiple term intersection among the set of kernels of the polynomial expressions.

Therefore, according to the theorem, any multiple variable common subexpression can be detected by an intersection among the set of kernel expressions. Furthermore, each kernel and co-kernel pair represents a possible factorization opportunity.

As a proof of this theorem, consider the case when there is a multiple term common subexpression, which satisfies the definition of a kernel (there is no literal or cube that can completely divide the kernel expression). In that case, either this subexpression is generated as a kernel during the kernel generation process or is a part of some kernel expression, since all kernels are generated in the kernel generation algorithm. Therefore if there is a multiple instance of this subexpression, then there will be multiple instances of it in the set of kernels that are generated. Therefore an intersection among the set of kernels can detect the common subexpression. For the case that the common subexpression does not satisfy the definition of a kernel, then it can be converted into a kernel expression by division by the common literal or cube. Again reasoning as above, this common subexpression can be detected by an intersection among the set of kernels.

FIG. 5 is a set of all kernels and co-kernels generated for the example polynomial expressions. It contains the equation 36 which has the example polynomial expressions, where the numbers in subscripts in each term represents the term number in the set of expressions. Equation 46 shows the set of kernels and the corresponding co-kernels. The co-kernels are in the square brackets and the kernels are in the round brackets.

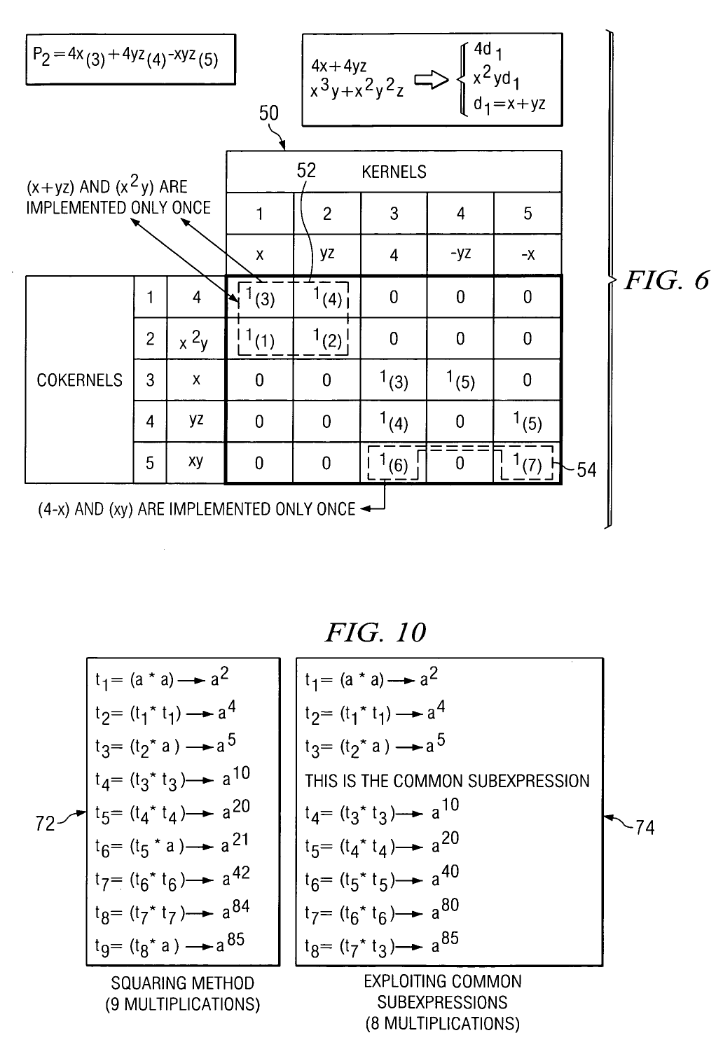

FIG. 6 is a simplified kernel-cube matrix 50 associated with the system. As illustrated in FIG. 6, (X+YZ) and (X²Y) are implemented once, as is illustrated by an element 52. In addition, (4-X) and (XY) are only implemented once, as is illustrated by an element 54. FIG. 6 illustrates a matrix transformation, which is used to find kernel intersections. Hence, the set of kernels generated is transformed into a matrix form called the Kernel Intersection Matrix (KIM) in order to find kernel intersections. There is one row for each kernel generated and one column for each distinct term in the set of kernel expressions.

FIG. 6 shows the KIM for our example polynomial expressions 20 from its set of kernels and co-kernels shown in FIG. 5. The original polynomials are not included in FIG. 6 to simplify representation. The rows are marked with the co-kernel of the kernel, which it represents. Each kernel intersection appears in the matrix as a rectangle. A rectangle is defined as a set of rows and columns such that its elements are ‘1’. The value of a rectangle is defined as the weighted sum of the savings in the number of additions and multiplications by selecting that rectangle as a multiple-term common subexpression or as a factor. The value of the rectangle can be calculated thus. Given a rectangle with the following parameters, we can calculate its value:

R=number of rows; M(Rᵢ)=number of multiplications in row (co-kernel) i. C=number of columns; M(Cᵢ)=number of multiplications in column (kernel-cube i). Each element (i,j) in the rectangle represents a product term equal to the product of co-kernel i and kernel-cube j, which has a total number of M(Rᵢ)+M(Cᵢ)+1 multiplications. The total number of multiplications represented by the whole rectangle is equal to

$${R}^{*} {\sum }_{C} M ( {C}_{i} ) + {C}^{*} {\sum }_{R} M ( {R}_{i} ) + {R}^{*} C .$$

Each row in the rectangle has C-1 additions for a total of R*(C-1) additions. By selecting the rectangle, we extract a common factor with

$${\sum }_{C} M ( {C}_{i} )$$

multiplications and C-1 additions. This common factor is multiplied by each row which leads to a further

$${\sum }_{R} M ( {R}_{i} ) + R$$

multiplications. The value of the rectangle can be described as the weighted sum of the savings in the number of multiplications and additions and is given by the following Equation I:

$${Value}_{1} = {m}^{*} \{ {( C - 1 )}^{*} ( R + {Σ}_{R} M ( {R}_{i} ) ) + {( R - 1 )}^{*} ( {Σ}_{C} M ( {C}_{i} ) ) \} + {( r - 1 )}^{*} ( C - 1 ) \qquad ( I )$$

The weighing factor ‘m’ can be selected by the designer depending on the relative cost of a multiplication and addition on the target architecture. For example multiplication takes about five times more cycle time than addition on an ARM processor.

Finding the best set of common subexpressions and factors for the minimum number of multiplications and additions is equivalent to finding the best set of non-overlapping rectangles in the KIM, which is analogous to the minimum weighted rectangular covering problem in multi-level logic synthesis. The resultant is a simplified set of operations that achieve the same final result as the more complex equation, which was used as an initial starting point.

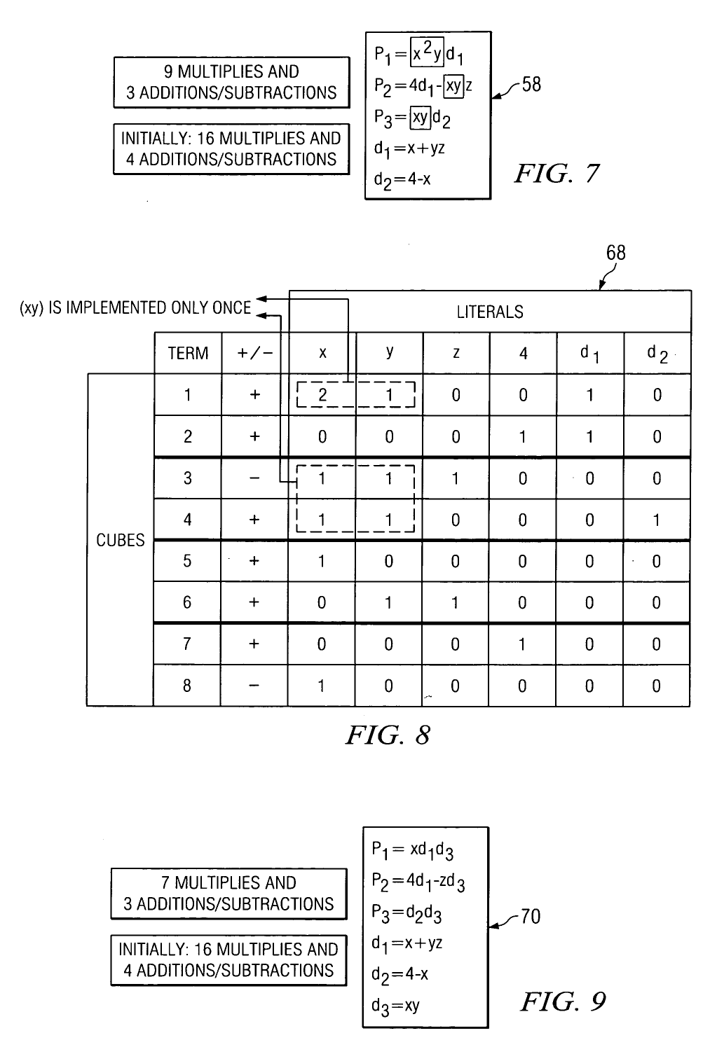

FIG. 7 is a simplified diagram illustrating an optimization 58 of the polynomial expressions. This is obtained after extracting all kernel intersections. This yields nine multiplies and three additions/subtractions. Kernel extraction only eliminates multiple term common subexpressions and performs factorization. There has to be a technique to find single term common subexpressions that are not found by the previous technique. It is possible to reduce the number of operations by finding single term common subexpressions. From FIG. 7 it can be seen that the term “xy” item has been represented several times. This is a common factor that can be used for purposes of optimization. After extracting that common subexpression, the subsequent implementation includes nine multiplies and three additions/subtractions, as is illustrated.

FIG. 8 is a simplified example diagram of a Cube Literal Matrix (CLM) 68 for the polynomial expressions. This matrix is constructed to eliminate the single term common subexpressions after the kernel extraction procedure has been completed. The CLM is constructed by having a row for each term and a column for each variable, for the expressions obtained at the end of the kernel extraction process. Each element (i,j) of this matrix represents the exponent of the variable j in the cube (term) i.

Each cube intersection (single term common subexpression) appears in the matrix (CLM) as a rectangle. A rectangle in the CLM is defined as a set of rows and columns such that all the elements are non-zero. The value of a rectangle is the number of multiplications saved by selecting the single term common subexpression corresponding to that rectangle. The best set of common cube intersections is obtained by a maximum valued covering of the CIM. The common cube C corresponding to the prime rectangle is obtained by finding the minimum value in each column of the rectangle. The value of a rectangle with R rows can be calculated as follows. Let ? C[i] be the sum of the integer powers in the extracted cube C. This cube saves ? C[i]-1 multiplications in each row of the rectangle. The cube itself needs ? C[i]-1 multiplications to compute. Therefore, the value of the rectangle is given by the equation:
Value₂=(R-1)*(? C[i]-1) (II)

From the CLM in FIG. 8, a rectangle corresponding to the set of rows {1,3,4} and the column corresponding to the variable set {x,y} can be seen which corresponds to the common subexpression. Eliminating this common subexpression will save two multiplications, as can be seen from the Value function in Equation II. After eliminating this common subexpression there are no more rectangle in the CLM matrix and the algorithm terminates. The final optimized expressions can be seen in FIG. 9. These expressions have a total of only seven multiplications and three additions/subtractions. This is a big improvement over the initial representation that had 16 multiplication and four additions/subtractions. Equation 70 in FIG. 9 shows the final optimized expressions. Thus, the resultant of the operations of system 10 yields a significant reduction in operations, which provides for less power consumption and smaller area configurations. Processing hardware design, in particular, could benefit greatly from such an approach.

It should also be noted that one or more functions of the polynomial expressions can readily be changed. Methods presented herein can also be adapted to the problem of optimizing polynomial expressions that have large integer exponents. Applications such as the RSA cryptosystem are based on very large (modular) exponentiation of messages for encryption and decryption, where optimizations for reducing the number of multiplications can be very useful. The number of multiplications can be reduced by finding common digit patterns in the binary representation of the integer exponents. As an example, consider the integer exponentiations F₁=a⁸⁵. If this is computed using the popular squaring method, it would result in a total of nine multiplications. However, if we look at the binary representation of 85=“1010101,” we can detect the common pattern “101.” This is equivalent to the computation a⁵. By using this common expression, we can compute a⁸⁵=a⁵*(a⁵*a⁵)⁸. a⁵ can be computed using the squaring method using five multiplications. Therefore, a⁸⁵ can be computed using eight multiplications (one fewer than the earlier identified method). The computation involved in computing a⁸⁵ using a method of squaring and a method of exploiting common subexpressions is shown in FIG. 10. An equation 72 shows that the squaring method requires nine multiplications and an equation 74 shows that the method requires only eight multiplications. The common digit patterns can be found using the rectangle covering methods (potentially with) some minor modifications. Firstly, the integer exponents have to be represented in binary. Kernels of these exponents are then defined as binary patterns where the first and last digits of the patterns are both 1. These kernels are then arranged in a Kernel Intersection Matrix (KIM) that was explained earlier. Common bit patterns can be detected by finding rectangles in this KIM.

Some of the steps illustrated in the preceding FIGURES may be changed or deleted where appropriate and additional steps may also be added to the proposed process. These changes may be based on specific system architectures or particular arrangements or configurations and do not depart from the scope or the teachings of the present invention. It is also critical to note that the preceding description details a number of techniques for reducing operations. While these techniques have been described in particular arrangements and combinations, system 10 contemplates using any appropriate combination and ordering of these operations to provide for decreased operations in polynomial expressions 20. As discussed above, identification of the common subexpressions may be facilitated by rectangle covering, ping-pong algorithms, or any other process, which is operable to facilitate such identification tasks. Considerable flexibility is provided by the present invention, as any such permutations are clearly within the broad scope of the present invention.

Although the present invention has been described in detail with reference to particular embodiments illustrated in FIGS. 1 through 10, it should be understood that various other changes, substitutions, and alterations may be made hereto without departing from the spirit and scope of the present invention. For example, although the present invention has been described with reference to a number of elements included within system 10, these elements may be rearranged or positioned in order to accommodate any suitable processing and communication architectures. In addition, any of the described elements may be provided as separate external components to system 10 or to each other where appropriate. The present invention contemplates great flexibility in the arrangement of these elements, as well as their internal components. Moreover, the algorithms presented herein may be provided in any suitable element, component, or object. Such architectures may be designed based on particular processing needs where appropriate,

Numerous other changes, substitutions, variations, alterations, and modifications may be ascertained to one skilled in the art and it is intended that the present invention encompass all such changes, substitutions, variations, alterations, and modifications as falling within the scope of the appended claims.

What is claimed is:

1. A method for optimizing polynomial expressions, comprising:
generating kernels in order to form a kernel and co-kernel matrix;
generating a cube literal matrix, which includes a plurality of cubes;
identifying rectangles on the kernel and co-kernel matrix;
using the rectangles to find common factors between the kernels;
identifying the rectangles on the cube literal matrix; and
using the rectangles to find common factors between the cubes.

2. The method of claim 1, wherein one or more operations that are reduced as a result of finding the common factors between the cubes relate to subtraction, addition or multiplication.

3. The method of claim 1, wherein one or more functions of the polynomial expressions can be changed, and wherein one or more of the polynomial expressions have large integer exponents.

4. The method of claim 1, further comprising:
using the common factors to optimize powers of variables that correspond to the polynomial expressions.

5. The method of claim 1, wherein the method is performed in a digital signal processing environment.

6. The method of claim 1, further comprising:
identifying one or more of the common subexpressions using a rectangle covering algorithm algorithm.

7. A system for optimizing polynomial expressions, comprising:
means for generating kernels in order to form a kernel and co-kernel matrix;
means for generating a cube literal matrix, which includes a plurality of cubes;
means for identifying rectangles on the kernel and co-kernel matrix;
means for using the rectangles to find common factors between the kernels;
means for identifying the rectangles on the cube literal matrix; and
means for using the rectangles to find common factors between the cubes.

8. The system of claim 7, wherein one or more operations that are reduced as a result of finding the common factors between the cubes relate to subtraction, addition, or multiplication.

9. The system of claim 7, wherein one or more functions of the polynomial expressions can be changed, and wherein one or more of the polynomial expressions have large integer exponents.

10. The system of claim 7, further comprising:
means for using the common factors to optimize powers of variables that correspond to the polynomial expressions.

11. The system of claim 7, wherein the system is provided in a digital signal processing (DSP) environment.

12. The system of claim 7, further comprising:
means for identifying one or more of the common subexpressions using a rectangle covering algorithm.

13. The system of claim 7, further comprising:
generating a resultant, for one or more of the polynomials expressions, based on a reduction in operations associated with the polynomial expressions.

14. Software for optimizing polynomial expressions, the software being embodied in a computer readable medium and comprising computer code such that when executed is operable to:
generate kernels in order to form a kernel and co-kernel matrix;
generate a cube literal matrix, which includes a plurality of cubes;
identify rectangles on the kernel and co-kernel matrix;
use the rectangles to find common factors between the kernels;
identify the rectangles on the cube literal matrix; and
use the rectangles to find common factors between the cubes.

15. The medium of claim 14, wherein one or more operations that are reduced as a result of finding the common factors between the cubes relate to subtraction, addition, or multiplication.

16. The medium of claim 14, wherein one or more functions of the polynomial expressions can be changed.

17. The medium of claim 14, wherein the code is further operable to:
use the common factors to optimize powers of variables that correspond to the polynomial expressions.

18. The medium of claim 14, wherein the code is provided in a digital signal processing environment.

19. The medium of claim 14, wherein the code is further operable to:
identify one or more of the common subexpressions using a rectangle covering algorithm or a ping-pong algorithm.

20. The medium of claim 14, wherein the code is further operable to:
generate a resultant, for one or more of the polynomial expressions, based on a reduction in operations associated with the polynomial expressions.
